(19) United States
(12) Patent Application Publication
(10) Pub. No.: US 2007/0203250 A1
(43) Pub. Date: Aug. 30, 2007

(54) Modified Double-Layer Clay Minerals, Method For The Production Thereof, And Use Thereof

(76) Inventors: Markus Hauser-Fuhlberg, Karlsruhe (DE); Rolf Nueesch, Karlsruch (DE); Marian Janek, Bratislava (SK); Hisham Essawi, Cairo (EG)

Correspondence Address: FRIEDRICH KUEFFNER, 317 MADISON AVENUE, SUITE 910, NEW YORK, NY, 10017, US

(21) Appl. No.: 10/571,422

(22) PCT Filed: Sep. 2, 2004
(86) PCT No.: PCT/EP04/52298

§ 371 Date: Dec. 8, 2006

(30) Foreign Application Priority Data
Sep. 18, 2003 (DE) 103 43 130.6

(51) Int. Cl. B01J 13/00

(52) U.S. Cl. 516/98

(57) ABSTRACT

The invention relates to modified double-layer clay minerals which are characterized in that they contain embedded organic molecules. Also disclosed are a method for the production thereof and the use thereof.

The present invention relates to modified double-layer clay minerals, characterized in that they contain embedded organic molecules, a method for the production thereof and the use thereof.

Double-layer clay minerals, e.g. kaolins or kaolinitic clays, have been used for centuries in construction chemistry and ceramics and as a starting material for high-quality porcelain. Today, these clays are much more widely used. Kaolins have in the meantime acquired fundamental importance in the production of paper, sanitary products, plastics, adhesives, paints, finishes, pharmaceutical products, cosmetics, glass fibers and rubber (natural latex and synthetic products). With the definition of functional fillers and simultaneous development of engineered minerals, a large number of new fields of use have arisen in addition to the classical areas of use, and the application-oriented modification of the clay surface is becoming increasingly important for exploiting said new fields of use. Printability, optical (brightness, opacity, gloss, porosity) and mechanical properties (tensile strength and impact resistance), but also structure, density, particle distribution, electrical and thermal conductivity, light refraction and the barrier effect (inter alia CO₂, O₂, UV) in polymer materials are important quality criteria.

Kaolins generally form as a result of weathering or hydrothermal conversion of volcanic glasses and feldspar-carrying silicate rocks (granite, gneiss, arcose). Clay minerals of the kaolinite group are the main constituents of the kaolins. Kaolinite is an aluminohydrosilicate with a sheet structure (phyllosilicate). The chemical formula is Al₂[Si₂O₅(OH)₄]. An elemental layer (TO layer packet) is formed from [Al(O,OH)₆] octahedra linked to form a layer and [SiO₄] tetrahedra linked to form a layer. The structure of this layer silicate is defined by a sequence of layer packets and intermediate layers. There are scarcely any substitutions of the tetrahedral and octahedral cations. The octahedral layer surfaces have hydroxyl groups toward the intermediate layers. The layer packets are linked to one another predominantly by hydrogen bridge bonds.

According to the prior art to date, complicated pretreatments are required for the development of layer silicate-polymer nanocomposites. The layer silicates used are primarily the clay minerals of the smectite family, which are swellable under natural conditions and are 3-layer clay minerals. They have, on the inner surfaces of the intermediate layers, charges which are compensated by the cations embedded in the intermediate layers, with the result that the individual layer packets hold together. These cations may be hydrated and thus expand the intermediate layers. The most well known member of the smectites, montmorillonite, can, if the intermediate layers are occupied exclusively by sodium, absorb so much water that it tends to undergo complete delamination. Consequently, many montmorillonites must be subjected to cation exchange before modification to give the polymer-composite building block, in most cases calcium being exchanged for sodium. In the modification method, the sodium ions are then replaced by so-called compatibilizers, e.g. tertiary amines, as described, for example, in EP 1 055 706. Owing to the modification, which now imparts a hydrophobic character to the clay mineral surface occupancy and permits coupling to the matrix polymer, there is no covalent bond directly between clay mineral and matrix polymer.

Kaolinite, a double-layer clay mineral which has no surface charges, has been used for decades as a filler in the plastics industry. Kaolinite is a pure filler and is present in particle sizes from one to several micrometers. The clay mineral floats so to speak in the polymer matrix and gives the plastic properties which are slightly new to date. However, owing to its catalytic properties, kaolinite can advantageously influence a polymerization process (GB 758 010, GB 838 368, GB 1 082 278). Kaolinite as coating material or flow improver has proved excellent for the storability of elastomers (DE 39 37 799).

As a result of the specific bonding properties of the individual layer packets of kaolinite, which are held together only by the polar character thereof and hydrogen bridge bonds, it is possible by means of tailor-made molecules to intercalate the intermediate layers of kaolinite which are otherwise not swellable under natural conditions. In addition, kaolinite has, in the accessible octahedral layer surfaces, hydroxyl groups which can serve as anchor sites for monomers in polymerization reactions. U.S. Pat. No. 3,080,256 discloses the modification of various clay minerals—including kaolin—by reacting them in an aqueous medium first with polyamines and then with organic compounds. As a result of this, the clay minerals modified in this manner achieve better wettability and dispersibility in organic systems.

The 3-layer clay minerals used to date all have surface charges which make an “ammonium compound treatment” indispensable, this treatment having adverse effects on the polymer-nanocomposite with regard to optical transparency and incomplete delamination of the layer silicate in the matrix polymer.

It is an object of the present invention to provide a method for the production of modified double-layer clay minerals which, however, do not have the disadvantages of the 3-layer clay minerals known to date.

This object is achieved by a method in which,

in a first step,

a) alkali metal acetate and/or ammonium acetate in aqueous solution are mixed with the double-layer clay mineral, with the result that the acetate is embedded in the double-layer clay mineral, and
   in a second step,
b) organic molecules are mixed, with or without further solvent, with the double-layer clay mineral obtained in step a), with the result that organic molecules are embedded in the double-layer clay mineral.

Double-layer clay minerals modified according to the invention are preferred. It is advantageous if the modified double-layer clay minerals are based on clay minerals from the group consisting of the kaolinites, particularly preferably halloysite, dickite, nacrite and kaolinite, especially preferably kaolinite.

In a preferred embodiment, the acetate embedded in step a) is displaced completely or at least partly.

The embedding of the acetate is effected at temperatures of from 15° C. to 30° C., preferably at room temperature.

In the context of the present invention, room temperature means about 20° C.

The embedding of the organic molecules can be effected at temperatures of ≧15° C., preferably ≧35° C., particularly preferably ≧50° C., especially preferably ≧60° C.

Step b) can be divided into two successive, separate steps, first step b1) comprising the actual mixing in a period of from 5 minutes to 24 hours, and step b2) comprising storage, optionally at elevated temperature, over a period of from a few hours to 14 days. The period which steps b1) and b2) comprise depends in each case on the desired degree of embedding. If a low degree of embedding is desired, the period should be chosen to be short; if on the other hand greater or (virtually) complete embedding is to take place, a long period should be chosen. The degree of embedding reached during the period can easily be determined by interim sampling; when the desired degree of embedding is reached, step b1) or b2) is then simply terminated.

According to the invention, step b2) is carried out at temperatures of ≧15° C., preferably ≧35° C., particularly preferably ≧50° C., especially preferably ≧60° C. According to the invention, step b1) can be carried out independently of b2), likewise at temperatures of ≧15° C. It is however preferable that step b1) is carried out at temperatures of from 15° C. to 30° C., most preferably at room temperature.

The acetate to be embedded in step a) is selected, according to the invention, from the group consisting of ammonium and/or alkali metal acetates. It is accordingly possible to use both ammonium acetate and acetates of the various alkali metals. It is possible to use both a specific acetate and a combination of different acetates, it being preferable not to use a combination.

Preferred acetates for step a) are, according to the invention, ammonium acetate and potassium acetate.

It is particularly advantageous according to the invention and therefore particularly preferred if the acetate used in step a) is potassium acetate.

The organic compounds which can be used for displacing the acetate are initiator molecules and/or monomer molecules for polymerization reactions.

Initiator molecules are understood as meaning those organic compounds which carry one or more functional groups which, through thermal excitation or excitation by radiation or other catalytic excitation, are capable of initiating a polymerization reaction. An example of such a functional group is e.g. the ═N—Br group in N-bromosuccinimide, which can act as a free radical initiator. Monomer molecules are those organic compounds which carry functional groups, which, in a polymerization reaction, can result in these compounds being incorporated into the polymer. Such groups are, for example, carbon-carbon double bonds which can be subjected to free radical polymerization.

Further embodiments of the initiator molecules and/or monomer molecules are familiar to the person skilled in the art and need not be mentioned here.

The organic compounds to be embedded according to the invention must be capable of forming hydrogen bridge bonds. Examples of these are those compounds which are selected from the group consisting of compounds having the functional groups —OH, —SH, ═NH, —NR₁R₂, —CO—NR₁R₂, ═O, —O— and/or X where X is any desired halogen and R₁ and R₂, in each case independently of one another, are hydrogen or an optionally substituted alkyl or alkylene radical having 1 to 10 carbon atoms, in particular a methyl or vinyl radical. According to the invention, the following are particularly suitable for the organic compounds:
A) hydroxyl-functional compounds, in particular ethylene glycol, glycerol, triethylene glycol and polyethylene glycols; less preferably triethylene glycol monomethyl ether;
B) mercapto compounds, in particular ethane-1,2-dithiol;
C) compounds containing imino or amino groups, in particular N-methylformamide, N-vinylacetamide and acrylamide;
D) halogen-functional compounds, in particular bromomaleic-anhydride, N-bromosuccinimide, diethyl meso-2,5-dibromoadipate, 4-chlorocatechol, tetrabromocatechol and 3-chloropropanesulfonyl chloride;
E) compounds containing allyl and/or vinyl groups, in particular methylenesuccinic acid, 2-hydroxyethylene methacrylate, poly(ethylene glycol) methacrylate, preferably having a weight average molecular weight M_{w} of 360.

The method according to the invention may optionally also comprise the addition of polymerization inhibitors in step b), in order, particularly at elevated temperatures, to suppress premature polymerization if this is not yet desired at this time.

In the method according to the invention, organic solvents and/or water can optionally be added in step b). This addition has two effects: firstly, the organic compounds to be embedded are dissolved or dispersed, which facilitates the handling thereof, and, secondly, the mixing of organic compound and double-layer clay mineral is facilitated by an addition of organic solvent and/or water.

The invention accordingly also relates to the modified double-layer clay minerals obtainable by the method according to the invention.

The modified double-layer clay minerals according to the invention and the modified double-layer clay minerals produced on the basis of the method according to the invention are used for the production of nanocomposites.

The latter in turn are used—exactly like the modified double-layer clay minerals as such—in the production of paper, sanitary products, plastics, adhesives, paints, finishes, pharmaceutical products, cosmetics, glass fibers, rubber (natural latex and synthetic products), detergents and household cleaners.

The procedure for embedding organic compounds in the intermediate layers of a double-layer clay mineral instead of in 3-layer clay minerals, and the provision of organic compounds which is important for the respective polymerization process, are part of the present invention.

According to the invention, the surface of the octahedral layers of double-layer clay minerals is modified in such a way that their hydroxyl groups offer anchor sites for polymers. The polymers should be capable of being coupled by covalent bonds to the surface of the elemental layers. This coupling to the matrix polymers provides a wide range of improvements of product properties of the plastics. The further development of the coating technology is aimed at increasing the bond strength between the mineral surface and the matrix polymer. For the modification of the octahedral layer surfaces toward the intermediate layers, primarily polar molecules having a pronounced tendency to form hydrogen bridges are embedded in kaolinite. In kaolinite, the embedding of alkali metal acetates results in an increase in the basic layer spacing from 0.7 to 1.4 nm.

This opening of the intermediate layers permits, in the next treatment step, the embedding of monomers which are capable of forming hydrogen bridges. By additional embedding of suitable organic compounds, defined polymerization reactions can be carried out in the intermediate layer space. The modified double-layer clay minerals provided in the invention can be used, for example, in free radical polymerization, atom transfer radical polymerization (ATRP) or UV-initiated polymerization, with the result that polymers with clay minerals bound in the polymer can be obtained. The embedded molecules permit the design of both double-layer clay mineral-polymer compounds and polymer-polymer compounds. Depending on the problem, the desired properties of the double-layer clay mineral nanocomposite can therefore be produced. By the in situ polymerization in the double-layer clay mineral, for example, the delamination of the elemental layers can be achieved, leading to a homogeneous distribution of the elemental layers in the matrix polymer. As a result, constant material properties are guaranteed even in the nanoscale range.

An advantage of the present invention is the provision of kaolinite as a nanocomposite constituent in layer silicate nanocomposites, by means of which the embedding of tailor-made initiator or monomer molecules for simultaneous delamination and dispersing of the kaolinite in a matrix polymer (“in situ” polymerization in the intermediate layers of kaolinite and crosslinking with the matrix polymer with simultaneous formation of covalent bonds with it) is permitted.

Further advantages of the present invention are the opening up of the field of use for double-layer clay minerals, preferably kaolinite, in the area of the development of polymer-layer silicate nanocomposites with simultaneous minimization of costs through omission of complicated cation exchange processes in the pretreatment of three-layer silicates, and the provision of intercalation compounds in double-layer clay minerals, preferably kaolinite, for a very wide range of polymerization processes according to the type of matrix polymer desired.

The methods described above extend, for example, the range of use of kaolinites used in the paper industry.

In the manner described in the present invention, kaolinite can replace the 3-layer clay minerals as a nanocomposite constituent in a simple and more economical pretreatment method. In addition, the field of use of kaolinite is extended by its property as a functional filler with the formation of covalent bonds to the matrix polymer.

The present invention also comprises those modified double-layer clay minerals in which a polymerization takes place during the embedding of the organic compounds itself. The present invention also comprises those modified double-layer clay minerals in which a polymerization takes place during the embedding of the organic compounds itself and which thereby undergo delamination during the embedding or the polymerization.

For achieving polymer-controlled delamination of the double-layer clay mineral, the invention comprises two concepts:
(I) Uncontrolled conditions—first the suitable monomer is embedded in the intermediate layers of the double-layer clay mineral, which causes delamination by spontaneous or thermally initiated polymerization. This behavior was observed, for example, in the case of poly(ethylene glycol) methacrylate (PEGMA).
The PEGMA-double-layer clay mineral was treated by way of experiment with the solvents such as acetone, tetrahydrofuran, ethyl acetate, toluene, dioxane and chloroform. The PEGMA-based polymer composite prepared was found to be not very soluble in the abovementioned solvents, chloroform giving the best results with regard to the solubility.
(II) Controlled conditions—first a suitable substance is embedded in the intermediate layers of the double-layer clay mineral, which substance serves as a reactant for a subsequent polymerization, such as, for example, a polycondensation, or which can serve as an initiator for ATRP or possibly UV-initiated polymerization. During the subsequent—initiated—polymerization reaction, delamination of the double-layer clay mineral layers is then caused by this polymerization.

### EXAMPLES

If water is used in the following examples, it is bidistilled water.

The embedding of the foreign molecules and the degree of embedding were determined by means of X-ray diffractometry (XRD).

Embedding can be detected by a reflection shift from ˜14 Å (d₍₀₀₁₎ reflection of potassium acetate kaolinite) to ˜11 Å, the exact value depending on the compound embedded.

The d₍₀₀₁₎ reflection of untreated kaolinite is 7.2 Å.

For the sake of clarity, only “d” will be written instead of “d₍₀₀₁₎” for the XRD reflections in the examples.

Step a):

A prepared kaolin (proportion of kaolinite >9%) and potassium acetate were used for the pretreatment. The potassium acetate was introduced in aqueous solution at room temperature into the kaolinite. The weight ratio of kaolinite to acetate salt to water is 62% to 27% to 11%. The potassium acetate kaolinite pretreated in this manner is further treated according to its monomer/initiator molecule to be embedded (examples 1 to 17 see below).

Step b):

### Example 1)

5 g of potassium acetate kaolinite were weighed into 250 ml polyethylene(PE) bottles at 20° C. and 100 ml of etylene glycol were added. Thereafter, the samples were shaken for 1 hour in an overhead shaker and then left to stand at 20° C. After 4 and 14 days, the solids content was separated from the dispersion by centrifuging.

XRD: complete embedding with d=10.8 Å

### Example 2)

2.1)

5 g of potassium acetate kaolinite in 50 ml of glycerol (anhydrous=AN) were shaken for 3 days in an overhead shaker and then left to stand at 20° C. After 4 days, the solids content was separated from the dispersion by centrifuging.

XRD: embedding with d=11.1 Å

2.2) (Comparison)

5 g of kaolinite in 50 ml of AN glycerol and shaken for 3 days in an overhead shaker and then left to stand at 20° C. After 4 days, the solids content was separated from the dispersion by centrifuging.

XRD: no changes in the diffractogram compared with starting material.

### Example 3)

3.1)

10 g of potassium acetate kaolinite and 100 ml of polyethylene glycol having a molecular weight of ˜200 (═PEG 200) were shaken in a 250 ml PE wide-necked bottle for 24 hours in an overhead shaker and then left to stand at 20° C. After 7 days, the solids content was separated from the dispersion by centrifuging.

XRD: embedding with d=12 Å

3.2)

10 g of potassium acetate kaolinite and 100 ml of PEG 200 were shaken in a 250 ml PE wide-necked bottle for 24 hours in an overhead shaker and then left to stand at 20° C. After 7 days, the solids content was separated from the dispersion by centrifuging.

XRD: embedding with d=11 Å

3.3)

10 g of potassium acetate kaolinite and 100 ml of PEG 400 were shaken in a 250 ml PE wide-necked bottle for 24 hours in an overhead shaker and then left to stand at 20° C. After 7 days, the solids content was separated from the dispersion by centrifuging.

XRD: embedding with d=11 Å

3.4)

10 g of potassium acetate kaolinite and 100 ml of PEG 400 were shaken in a 250 ml PE wide-necked bottle for 24 hours in an overhead shaker and then left to stand at 40° C. After 7 days, the solids content was separated from the dispersion by centrifuging.

XRD: embedding with d=11 Å

3.5)

10 g of potassium acetate kaolinite and 100 ml of PEG 600 were shaken in a 250 ml PE wide-necked bottle for 24 hours in an overhead shaker and then left to stand at 40° C. After 7 days, the solids content was separated from the dispersion by centrifuging.

XRD: embedding with d=11 Å

3.6)

10 g of potassium acetate kaolinite and 100 ml of PEG 600 were shaken in a 250 ml PE wide-necked bottle for 24 hours in an overhead shaker and then left to stand at 60° C. After 7 days, the solids content was separated from the dispersion by centrifuging.

XRD: embedding with d=11 Å

3.7)

10 g of potassium acetate kaolinite and 100 ml of PEG 600 were shaken in a 250 ml PE wide-necked bottle for 24 hours in an overhead shaker and then left to stand at 80° C. After 7 days, the solids content was separated from the dispersion by centrifuging.

XRD: embedding with d=11 Å

### Example 4)

5 g of potassium acetate kaolinite were shaken in 50 ml of triethylene glycol (TEG) in a closed 250 ml PET bottle in an overhead shaker and then left to stand at 20° C. After 7 days, the solids content was separated from the dispersion by centrifuging.

XRD: embedding with d=11.7 Å and d=11.1 Å

### Example 5)

5.1) (Comparison)

2 g of kaolinite were shaken in 15 ml of triethylene glycol monomethyl ether (TEGMME) in a 30 ml sample tube with a snap-on lid on a shaking bench at a low frequency for 24 hours at 20° C. After 4 days, the solids content was separated from the dispersion by centrifuging.

XRD: no embedding

5.2)

2 g of potassium acetate kaolinite were shaken in 15 ml of TEGMME in a closed 250 ml PET bottle in a 30 ml sample tube with a snap-on lid on a shaking bench at a low frequency for 24 hours at 20° C. After 4 days, the solids content was separated from the dispersion by centrifuging.

XRD: partial (about 5%) embedding with d=11.38 Å

5.3) (Comparison)

2 g of kaolinite deintercalated with water were shaken in 15 ml of TEGMME in a 30 ml sample tube with a snap-on lid on a shaking bench at a low frequency for 24 hours at 20° C. After 4 days, the solids content was separated from the dispersion by centrifuging.

XRD: no embedding

### Example 6)

In each case 1 g of potassium acetate kaolinite was brought into suspension with 10 ml of 2-mercaptoethanol. Rapid dispersing is observed, with an opalescence effect typical of kaolinite. After 72 hours, the solids content was separated from the suspension by centrifuging.

XRD: about 50% embedding with d=11.9 Å

### Example 7)

Preparation: 30 g of n-vinylacetamide (NVA) (1 cm salt crystal aggregates) were dissolved in 4 ml of water by means of a magnetic stirrer. About 34 ml of NVA solution resulted.

7.1) (Comparison)

1 g of kaolinite and 4 ml of NVA solution were shaken in a 20 ml bottle in an overhead shaker for 1 hour for complete homogenization of the dispersion and then left to stand at 20° C. After 7 days, the solids content was separated from the dispersion by centrifuging.

XRD: no embedding

7.2) (Comparison)

1 g of kaolinite and 4 ml of NVA solution were shaken in a 20 ml bottle in an overhead shaker for 1 hour for complete homogenization of the dispersion and then left to stand at 65° C. After 7 days, the solids content was separated from the dispersion by centrifuging.

XRD: no embedding

7.3)

1 g of potassium acetate kaolinite and 4 ml of NVA solution were shaken in a 20 ml bottle and in an overhead shaker for 1 hour for complete homogenization of the dispersion and then left to stand at 20° C. After 7 days, the solids content was separated from the dispersion by centrifuging.

XRD: no embedding

7.4)

1 g of potassium acetate kaolinite and 4 ml of NVA solution were shaken in a 20 ml bottle in an overhead shaker for 1 hour for complete homogenization of the dispersion and then left to stand at 65° C. After 7 days, the solids content was separated from the dispersion by centrifuging.

XRD: complete embedding with d=10.7 Å

### Example 8)

Preparation: dissolve 2 g of acrylamide in 4 ml of water with stirring.

8.1)

250 mg of potassium acetate kaolinite were shaken with 1 ml of acrylamide in 2 ml headspace bottles in an overhead shaker for 1 hour for complete homogenization of the dispersion and then left to stand at 20° C. After 7 days, the solids content was separated from the dispersion by centrifuging.

XRD: virtually complete embedding with d=11 Å

8.2)

250 mg of potassium acetate kaolinite were shaken with 1 ml of acrylamide in 2 ml headspace bottles in an overhead shaker for 1 hour for complete homogenization of the dispersion and then left to stand at 65° C. After 7 days, the solids content was separated from the dispersion by centrifuging.

XRD: virtually complete embedding with d=11 Å

8.3) (Comparison)

250 mg of kaolinite were shaken with 1 ml of acrylamide in 2 ml headspace bottles in an overhead shaker for 1 hour for complete homogenization of the dispersion and then left to stand at 20° C. After 7 days, the solids content was separated from the dispersion by centrifuging.

XRD: no embedding

8.4) (Comparison)

250 mg of kaolinite were shaken with 1 ml of acrylamide in 2 ml headspace bottles in an overhead shaker for 1 hour for complete homogenization of the dispersion and then left to stand at 65° C. After 7 days, the solids content was separated from the dispersion by centrifuging.

XRD: no embedding

8.5) (Comparison)

250 mg of deintercalated potassium acetate kaolinite were shaken with 1 ml of acrylamide in 2 ml headspace bottles in an overhead shaker for 1 hour for complete homogenization of the dispersion and then left to stand at 20° C. After 7 days, the solids content was separated from the dispersion by centrifuging.

XRD: no embedding

8.6) (Comparison)

250 mg of deintercalated potassium acetate kaolinite were shaken with 1 ml of acrylamide in 2 ml headspace bottles in an overhead shaker for 1 hour for complete homogenization of the dispersion and then left to stand at 65° C. After 7 days, the solids content was separated from the dispersion by centrifuging.

XRD: no embedding

### Example 9)

Preparation: 500 mg of 4-chlorocatechol were dissolved in 2 ml of ethanol (>99.8%, AN) with stirring.

9.1) (Comparison)

250 mg of kaolinite were dried (150° C./48 h) and shaken with 1 ml of 4-chlorocatechol/ethanol solution in 2 ml headspace bottles in an overhead shaker for 1 hour for complete homogenization of the dispersion and then left to stand at 20° C. After 6 days, the solids content was separated from the dispersion by centrifuging.

XRD: no embedding

9.2)

250 mg of potassium acetate kaolinite were shaken with 1 ml of 4-chlorocatechol/ethanol solution in 2 ml headspace bottles in an overhead shaker for 1 hour for complete homogenization of the dispersion and then left to stand at 20° C. After 6 days, the solids content was separated from the dispersion by centrifuging.

XRD: no embedding

9.3) (Comparison)

250 mg of kaolinite were dried (150° C./48 h) and shaken with 1 ml of 4-chlorocatechol/ethanol solution in 2 ml headspace bottles in an overhead shaker for 1 hour for complete homogenization of the dispersion and then left to stand at 65° C. in a drying oven. After 3 days, the solids content was separated from the dispersion by centrifuging.

XRD: no embedding

9.4)

250 mg of potassium acetate kaolinite were shaken with 1 ml of 4-chlorocatechol/ethanol solution in 2 ml headspace bottles in an overhead shaker for 1 hour for complete homogenization of the dispersion and then left to stand at 65° C. in a drying oven. After 3 days, the solids content was separated from the dispersion by centrifuging.

XRD: embedding (about 30%) with d=11.5 Å

### Example 10)

Preparation: 500 mg of tetrabromocatechol were dissolved in 2 ml of ethanol (>99.8%, AN) with stirring.

10.1)

250 mg of potassium acetate kaolinite were shaken with 1 ml of tetrabromocatechol/ethanol solution in 2 ml headspace bottles in an overhead shaker for 1 hour for complete homogenization of the dispersion and then left to stand at 20°. After 14 days, the solids content was separated from the dispersion by centrifuging.

XRD: embedding with d=10.6 Å

10.2)

250 mg of ammonium acetate kaolinite were shaken in 1 ml of tetrabromocatechol/ethanol solution in 2 ml headspace bottles in an overhead shaker for 1 hour for complete homogenization of the dispersion and then left to stand at 20° C. After 14 days, the solids content was separated from the dispersion by centrifuging.

XRD: embedding with d=11.3 Å

10.3)

250 mg of potassium acetate kaolinite were shaken with 1 ml of tetrabromocatechol/ethanol solution in 2 ml headspace bottles in an overhead shaker for 1 hour for complete homogenization of the dispersion and then left to stand at 65° C. in a drying oven. After 14 days, the solids content was separated from the dispersion by centrifuging.

XRD: embedding with d=10.3 Å

10.4)

250 mg of ammonium acetate kaolinite were shaken with 1 ml of tetrabromocatechol/ethanol solution in 2 ml headspace bottles in an overhead shaker for 1 hour for complete homogenization of the dispersion and then left to stand at 65° C. in a drying oven. After 14 days, the solids content was separated from the dispersion by centrifuging.

XRD: embedding with d=11.3 Å

### Example 11)

11.1)

200 mg of potassium acetate kaolinite were mixed with 400 μl of 3-chloropropanesulfonyl chloride in 2 ml GC glass bottles under an N₂ atmosphere in a glove box, shaken in an overhead shaker for 1 hour for complete homogenization of the dispersion, closed with a crimped cap and then left to stand at 20° C. After 7 days, the solids content was separated from the dispersion by centrifuging.

XRD: complete embedding with d=9.9 Å

Subsequent washing with the aid of an overhead shaker in acetone under an argon atmosphere for 5 days showed that the product remained stable.

11.2)

200 mg of potassium acetate kaolinite were mixed with 400 μl of 3-chloropropanesulfonyl chloride in 2 ml GC glass bottles under an N₂ atmosphere in a glove box, shaken in an overhead shaker for 1 hour for complete homogenization of the dispersion, closed with a crimped cap and then left to stand at 60° C. After 7 days, the solids content was separated from the dispersion by centrifuging.

XRD: about 30% embedding with d=9.9 Å

This shows that potassium acetate is still embedded in the kaolinite. Subsequent washing with the aid of an overhead shaker in acetone under an argon atmosphere for 5 days showed that the product remained stable.

The degree of embedding is higher in the case of this product (about 70% relative to potassium acetate).

### Example 12)

Preparation: 1 g of diethyl meso-2,5-dibromoadipate were dissolved in 3 ml of ethanol (AN) with stirring.

12.1)

250 mg of potassium acetate kaolinite were shaken with 1 ml of diethyl meso-2,5-dibromoadipate/ethanol solution in 2 ml headspace bottles in an overhead shaker for 1 hour for complete homogenization of the dispersion and then left to stand at 20° C. After 6 days, the solids content was separated from the dispersion by centrifuging.

XRD: slight embedding with d=11.4 Å

12.2)

250 mg of potassium acetate kaolinite shaken with 1 ml of diethyl meso-2,5-dibromoadipate/ethanol solution in 2 ml headspace bottles in an overhead shaker for 1 hour for complete homogenization of the dispersion and then left to stand at 65° C. After 6 days, the solids content was separated from the dispersion by centrifuging.

XRD: complete embedding with d=11.4 Å

### Example 13)

Preparation: 1 g of N-bromosuccinimide were dissolved in 3 ml of ethanol (AN) with stirring.

13.1) (Comparison)

250 mg of kaolinite were shaken with 1 ml of N-bromosuccinimide in 2 ml headspace bottles in an overhead shaker for 1 hour for complete homogenization of the dispersion and then left to stand at 20° C. After 6 days, the solids content was separated from the dispersion by centrifuging.

XRD: no embedding

13.2)

250 mg of potassium acetate kaolinite were shaken with 1 ml of N-bromosuccinimide in 2 ml headspace bottles in an overhead shaker for 1 hour for complete homogenization of the dispersion and then left to stand at 20° C. After 6 days, the solids content was separated from the dispersion by centrifuging.

XRD: about 50% embedding with d=10.3 Å

13.3)

250 mg of kaolinite were shaken with 1 ml of N-bromosuccinimide in 2 ml headspace bottles in an overhead shaker for 1 hour for complete homogenization of the dispersion and then left to stand at 65° C. After 6 days, the solids content was separated from the dispersion by centrifuging.

XRD: no embedding

13.4)

250 mg of potassium acetate kaolinite were shaken with 1 ml of N-bromosuccinimide in 2 ml headspace bottles in an overhead shaker for 1 hour for complete homogenization of the dispersion and then left to stand at 65° C. After 6 days, the solids content was separated from the dispersion by centrifuging.

XRD: virtually complete embedding with d=10.3 Å

### Example 14)

14.1)

250 mg of potassium acetate kaolinite were mixed with 1000 μl of bromomaleic anhydride in 2 ml GC glass bottles under an argon atmosphere in a glove box, shaken in an overhead shaker for 1 hour for complete homogenization of the dispersion, closed with a crimped cap and then left to stand at 20° C. After 5 days, the solids content was separated from the dispersion by centrifuging.

XRD: delamination of the kaolinite

14.2)

250 mg of potassium acetate kaolinite were mixed with 1000 μl of bromomaleic anhydride in 2 ml GC glass bottles under an argon atmosphere in a glove box, shaken in an overhead shaker for 1 hour for complete homogenization of the dispersion, closed with a crimped cap and then left to stand at 65° C. After 5 days, the solids content was separated from the dispersion by centrifuging.

XRD: delamination of the kaolinite

14.3)

250 mg of kaolinite were mixed with 1000 μl of bromomaleic anhydride in 2 ml GC glass bottles under an argon atmosphere in a glove box, shaken in an overhead shaker for 1 hour for complete homogenization of the dispersion, closed with a crimped cap and then left to stand at 20° C. After 5 days, the solids content was separated from the dispersion by centrifuging.

XRD: no embedding

14.4)

250 mg of kaolinite were mixed with 1000 μl of bromomaleic anhydride in 2 ml GC glass bottles under an argon atmosphere in a glove box, shaken in an overhead shaker for 1 hour for complete homogenization of the dispersion, closed with a crimped cap and then left to stand at 65° C. After 5 days, the solids content was separated from the dispersion by centrifuging.

XRD: no embedding

Further experiments with dimethyl sulfoxide DMSO kaolinite (illustrative, not according to the invention):

Since the question of embedding is not unambiguously explained by the delamination, the embedding is described with DMSO kaolinite as a further example.

14.5)

250 mg of DMSO kaolinite were mixed with 1000 μl of bromomaleic anhydride in 2 ml GC glass bottles under an argon atmosphere in a glove box, shaken in an overhead shaker for 1 hour for complete homogenization of the dispersion, closed with a crimped cap and then left to stand at 20° C. After 7 days, the solids content was separated from the dispersion by centrifuging.

XRD: no embedding

14.6)

250 mg of DMSO kaolinite were mixed with 1000 μl of bromomaleic anhydride in 2 ml GC glass bottles under an argon atmosphere in a glove box, shaken in an overhead shaker for 1 hour for complete homogenization of the dispersion, closed with a crimped cap and then left to stand at 65° C. After 7 days, the solids content was separated from the dispersion by centrifuging.

XRD: high degree of embedding with d=12.5 Å

By means of this auxiliary experiment with DMSO, it is thus possible to show that bromomaleic anhydride is also embedded. In the case of the pretreatment, according to the invention, of the kaolinite with potassium acetate, however, the polymerization and, as a result, the delamination of the modified kaolinite takes place during the embedding itself, so that the embedding as such is not observable.

### Example 15)

5 g of potassium acetate kaolinite were shaken with 50 ml of 2-hydroxyethyl methacrylate in a 100 ml PE wide-necked bottle for 24 hours in an overhead shaker. Thereafter, 10 ml each were introduced into a headspace bottle and
a) left to stand at 20° C. After 7 days, the solids content was separated from the dispersion by centrifuging.
   XRD: embedding with d=11.9 Å
b) left to stand at 40° C. After 6 days, the solids content was separated from the dispersion by centrifuging.
   XRD: embedding with d=11.7 Å

### Example 16)

5 g of potassium acetate kaolinite were shaken with 50 ml of poly(ethylene glycol) methacrylate in a 100 ml PE wide-necked bottle for 24 hours in an overhead shaker. Thereafter, 10 ml each were introduced into a headspace bottle and
a) left to stand at 20° C. After 6 days, the solids content was separated from the dispersion by centrifuging.
   XRD: virtually complete embedding with d=12.3 Å
b) left to stand, at 40° C. in a drying oven. After 6 days, the solids content was separated from the dispersion by centrifuging.
   XRD: polymerization of the sample after embedding
c) left to stand at 65° C. in a drying oven. After 6 days, the solids content was separated from the dispersion by centrifuging.
   XRD: polymerization of the sample after embedding

In the case of examples 16b) and 16c), polymerization of the samples took place after storage for 24 hours.

### Example 17)

Preparation: 3 g of methylene succinic acid were dissolved in 9 ml of ethanol (AN) with stirring. (After 48 hours, the methylene succinic acid has not dissolved completely in spite of continuous stirring; the clear supernatant was used for the series of experiments.)

17.1)

250 mg of potassium acetate kaolinite were mixed with 1 ml of methylene succinic acid in 2 ml headspace bottles and then first shaken for 24 hours in an overhead shaker at 20° C. and then left to stand at 65° C. After 7 days, the solids content was separated from the dispersion by centrifuging.

XRD after 7 days: virtually complete embedding with d=11.6 Å

17.2)

250 mg of potassium acetate kaolinite were mixed with 1 ml of methylene succinic acid in 2 ml headspace bottles and then first shaken for 24 hours in an overhead shaker at 20° C. and then left to stand at 65° C. After 6 days, the solids content was separated from the dispersion by centrifuging.

XRD: virtually complete embedding with d=11.6 Å

1. A method for the production of modified double-layer clay minerals, wherein, in a first step,
a) alkali metal acetate and/or ammonium acetate in aqueous solution are mixed with the double-layer clay mineral, with the result that the acetate is embedded in the double-layer clay mineral, and
in a second step,
b) organic molecules are mixed, with or without further solvent, with the double-layer clay mineral obtained in step a), with the result that organic molecules are embedded in the double-layer clay mineral, and
in a third step,
c) a polymerization takes place during or after the embedding of the organic compounds.

2. The method as claimed in claim 1, wherein the acetate is completely or partly displaced by the organic molecules.

3. The method as claimed in claim 1, wherein step b) is effected in two part steps b1) and b2),
b1) comprising the actual mixing in a period of from 5 minutes to 24 hours and
b2) comprising storage, optionally at elevated temperature, over a period of from a few hours to 14 days.

4. The method as claimed in claim 1, wherein step a) is carried out at temperatures of from 15° C. to 30° C., preferably at room temperature.

5. The method as claimed in claim 4, wherein step b1) is carried out at temperatures of from 15° C. to 30° C., preferably at room temperature, and in that step b2) is carried out at temperatures of ≧15° C., preferably ≧35° C., particularly preferably ≧50° C., especially preferably ≧60° C.

6. The method as claimed in claim 1, wherein potassium acetate is used in step a).

7. The method as claimed in claim 1, wherein it are modified double-layer clay minerals based on clay minerals from the group consisting of the kaolinites, preferably halloysite, dickite, nacrite and kaolinite, particularly preferably kaolinite.

8. The method as claimed in claim 1, wherein the organic molecules are initiator molecules and/or monomer molecules for polymerization reactions.

9. The method as claimed in claim 1, wherein the organic molecules are compounds selected from the group consisting of compounds having the functional groups —OH, —SH, ═NH, —NR₁R₂, —CO—NR₁R₂, ═O, —O— and/or X where X is any desired halogen and R₁ and R₂, in each case independently of one another, are hydrogen or an optionally substituted alkyl or alkylene radical having 1 to 10 carbon atoms, in particular a methyl or vinyl radical.

10. The method as claimed in claim 1, wherein the double-layer clay minerals undergo delamination during the embedding or polymerization.

11. A modified double-layer clay mineral, wherein it can be produced by a method as claimed in claim 1.

12. The modified double-layer clay mineral as claimed in claim 11, which has at least two of the functional groups —OH, —SH, ═NH, —NR₁R₂, —CO—NR₁R₂, ═O, —O— and/or X where X is any desired halogen and R₁ and R₂, in each case independently of one another, are hydrogen or an optionally substituted alkyl or alkylene radical having 1 to 10 carbon atoms, in particular a methyl or vinyl radical, or at least one double bond between two carbon atoms.

13. The use of the modified double-layer clay minerals as claimed claim 11 for the production of nanocomposites.

14. The use of the modified double-layer clay minerals as claimed in claim 12 in free radical polymerization, atom transfer radical polymerization and/or UV-initiated polymerization.

15. The use of the modified double-layer clay minerals as claimed in claim 11 for the production of paper, sanitary products, plastics, adhesives, paints, finishes, pharmaceutical products, cosmetics, glass fibers, rubber (natural latex and synthetic products), detergents and household cleaners.
